(19) United States
(12) Patent Application Publication
(10) Pub. No.: US 2003/0106030 A1
(43) Pub. Date: Jun. 5, 2003

(54) Method and program product for compressing an electronic circuit model

(76) Inventors: S. Brandon Keller, Evans, CO (US); Gregory Dennis Rogers, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/998,174

(22) Filed: Dec. 3, 2001

(51) Int. Cl. G06F 17/50; G06F 9/45

(52) U.S. Cl. 716/4

(57) ABSTRACT

A method for compressing an integrated circuit model has steps of selecting a first net and compressing at least a second net connected to the first net by removing resistors and summing capacitors. Through steps of the present invention, the size and complexity of the integrated circuit model are thereby simplified while retaining information regarding the second net that may be required for analysis.

### FIELD OF THE INVENTION

The present invention is related to methods and program products for designing and evaluating electronic circuits. More particularly, the present invention is related to systems and methods for compressing a circuit model for use in performing circuit analysis.

### BACKGROUND OF THE INVENTION

Computer aided design (CAD) systems for the design of electronic circuits, which may be referred to as Electronic CAD (ECAD) systems, assist in the design of electronic circuits by providing a user with a set of software tools running on a digital computer with a graphical display device. ECAD tools are ideally suited to performing tasks associated with the circuit design process as they can reduce or decompose large, complicated circuits into a multitude of much simpler functions. Thereupon, the ECAD tools can iteratively solve these much simpler functions. Indeed, it has now come to the point where the design process has become so overwhelming that the current generation of integrated circuit (IC) chips, particularly in the case of very large scale integrated chips (VLSI), often cannot be designed without the help of ECAD systems.

In performing a circuit design task, the ECAD tool generally allows for a user to schematically create and/or edit circuit designs by graphically placing and connecting circuit components, which may be represented as objects by the ECAD tool. The ECAD tool performs calculational circuit design and evaluation tasks for the schematic circuit such as optimizing the circuit, testing the circuit through simulation modeling, and the like. As represented by the ECAD tool, the circuit may comprise a plurality of “nets”, with each net representing a connection between the terminals of two transistors. A net may also be referred to as a signal. An ECAD tool also typically generates a “netlist”, which is a list of a group of logically related nets, including connectivity data for each. The netlist may be in the form of a database. Also, the netlist may describe a multiplicity of nets that can number into the millions for VLSI related tasks. As a result, netlists can be of enormous size and complexity.

Different types or sub-tools of an ECAD tool may be used in IC design/evaluation tasks. A first ECAD tool may be used to generate/edit the IC schematics, which generally lay out the logical components and connections. A first ECAD generated netlist may be associated with the IC schematic, with this first netlist comprising a database listing all of the nets and their connectivity.

Following schematics, artwork for the IC may be created. Artwork generally comprises specifications for the physical connections used to create the nets of the IC. These physical connections generally comprise layers of conducting metallic materials laid onto the chip. These connections will have electrical properties associated with them, including a resistance and a capacitance. An ECAD tool may be used to perform an “RC extraction” on the artwork design. The RC extraction results in determination of resistance and capacitance equivalents for each net. That is, the RC extraction examines the physical conducting connection used for each net and determines its resistance and capacitance. A second netlist is then created, which builds on the first netlist by adding resistance and capacitance data for each net in the list.

This second netlist comprising resistance and capacitance (RC) data created by the ECAD RC extraction tool may be in the form of either a “distributed” or a “lumped” RC model. A distributed netlist RC model represents each net in the form of a plurality of resistors and capacitors, while a lumped model represents each net as a single resistor and a single capacitor. That is, a distributed model may represent the RC properties of a given net as a plurality of capacitors and resistors spaced along the path of the net from one another. Accordingly, distributed model netlists tend to be larger and more complex than lumped models.

Distributed models are required for modeling phenomenon along the path of the net. For example, as current passes through a net the metallic conductor layers will slowly change in physical form as electrons are shifted about. These changes will change the electrical properties of the net over time. Such a phenomenon may be referred to as electromigration (EM). Modeling EM effects is an important task in IC design/evaluation, as over time EM effects can cause IC degradation, timing changes, and eventual failure. Because a lumped RC model does not have sufficient information to allow for analysis of EM effects, ECAD tools require netlists that comprise a distributed RC model for such tasks.

In performing circuit design and testing functions ECAD tools consume a large amount of memory and processing resources. For example, in a VLSI chip containing a million transistors, the peak disk storage requirement can be of the order of terabytes. Because of the sheer number of electrical components within a single VLSI chip, particularly transistor components, ECAD VLSI designs are also computationally intensive, consuming substantial amounts of processor resources. A substantial portion of these required memory and processor resources are needed to accommodate the netlists.

Requiring such large amounts of memory and processing resources is disadvantageous for several reasons. For one, these resources have a cost associated with them, with the result that operation of ECAD systems can require relatively expensive computer systems. Additionally, such a high level of resource consumption can strain computer systems, leading to a high rate of software and potentially system crashes. Still an additional disadvantage relates to the speed of ECAD systems. Specifically, the large amount of data to be handled and the multiplicity of calculations can result in relatively slow ECAD performance, even when using high performance computer systems. These problems are particularly acute for certain ECAD operations. For example, operations that require manipulation of distributed model netlists for a VLSI design have an extremely high memory resource requirement that may max out a computer's memory.

Solutions to these problems have been proposed. Generally, these solutions involve compressing portions of the data to reduce required resources. For example, the practice of “carving” is known to reduce the size of a netlist when using the netlist for a task. Through carving, the nearby surroundings of a net being analyzed are removed from the netlist. That is, the net of interest is essentially “cut out” of its nearby surroundings. This allows for manipulation of the particular net without computationally following the effects through connected nearby nets that are not of interest.

While such practices can be successful for some limited applications, they are inadequate for many others. Often the full context of surrounding nets are required for effective analysis of a given net. For example, when analyzing a power grid on a VLSI design, it is impossible to remove the underlying circuits through carving to reduce required resources—it is those very circuits that will cause the power grid to fail. These connected circuits therefore need to be included in the analysis. Similarly, when conducting a current estimation for a circuit, it will be required to know capacitance that exists downstream of the circuit portion being tested. Thus carving around that circuit portion is not an acceptable solution.

These and other needs in the art remain unresolved.

### SUMMARY OF THE INVENTION

The present invention is directed to methods and systems for compressing integrated circuit models. An invention embodiment comprises steps of selecting at least a first net for analysis, and compressing at least a second net connected to the first net by removing the resistors from the second net and by summing all of the capacitors on the second net. Although those skilled in the art will appreciate that methods of the invention will have utility in a number of applications, embodiments of the present invention may find particular utility in VLSI applications, by way of example, that require power grid analysis or that require gross current estimation.

The present invention solves many otherwise unresolved problems in the art. For example, through compression of nets, the size of a netlist can be substantially reduced, thereby alleviating memory requirements for IC analysis tasks. Further, compression is achieved through novel method steps that comprise summarizing, but not carving out, secondary nets. These novel steps allow for tasks such as EM analysis to be performed, while also greatly reducing required memory resources.

Those knowledgeable in the art will appreciate that the present invention is well suited for practice in the form of a computer program product. Accordingly, embodiments of the present invention comprise computer program products that when executed generally cause a computer to carry out the steps of method embodiments of the invention when executed.

The above brief description sets forth broadly some features of the present disclosure so that the detailed description that follows may be better understood, and so that the present contributions to the art may be better appreciated. There are, of course, additional features of the disclosure that will be discussed hereinafter which will further describe the subject matter of the invention. In this respect, before explaining an embodiment of the disclosure in detail, it is to be understood that the disclosure is not limited in its application to the details of the construction and the arrangements set forth in the following description or illustrated in the drawings. The present invention is capable of other embodiments and of being practiced and carried out in various ways, as will be appreciated by those skilled in the art. Also, it is to be understood that the phraseology and terminology employed herein are for description and not limitation.

### BRIEF DESCRIPTION OF THE DRAWINGS

FIG. 1 is a flowchart illustrating an electromigration analysis embodiment of a method of the invention;

FIGS. 2(a) and 2(b) are circuit diagrams showing a portion of a representative circuit before and after compression, respectively, through a method embodiment of the invention

FIG. 3 is a flowchart illustrating a gross current estimation embodiment method of the invention; and

FIGS. 4(a) and 4(b) are circuit diagrams showing a portion of a representative circuit before and after compression, respectively, through a method embodiment of the invention.

### DETAILED DESCRIPTION

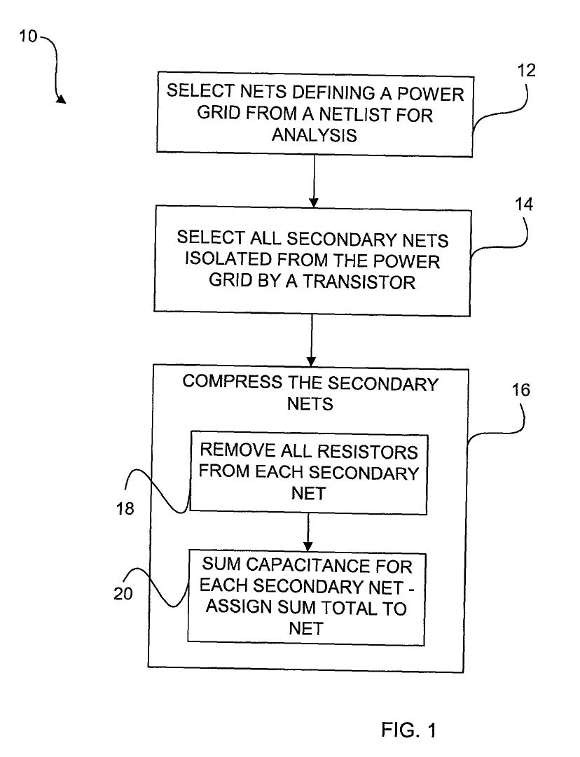

Turning now to the drawings, FIG. 1 is a flow chart illustrating an embodiment 10 of a method of the invention that may be of particular utility in performing an analysis of a power grid of an IC. For example, it may be desirable to perform such an analysis to predict electromigration that will occur over time with transmission of current through the power grid. Those knowledgeable in the art will appreciate that such an analysis can be a critical part of an IC design and/or evaluation process.

An ECAD tool is well suited for performing this task. In particular, an ECAD tool may be used to generate a netlist having a distributed model whereby nets are represented by a plurality of capacitors and resistors. Example ECAD tools that are commercially available and suitable for use in practice of methods of the invention are the “Voltage Storm” system from Simplex Solutions, Corp (Sunnyvale Calif.), and the “Railmill” system from Synopsis, Inc. (Mountainview, Calif.). It will be appreciated that the term “net” and “netlist” as used herein are intended to have a meaning consistent with their ordinary meaning in the art. For example, a “net” as used herein is intended to refer to a representation of a connection or “signal” on a circuit between transistor or other circuit component terminals. A “netlist” as used herein is intended to refer to a group of nets having some logical or physical connection.

A netlist distributed model is generally required for study of phenomenon such as electromigration effects. The netlist may be in table form, with each net having multiple data fields indicating size and relative position of capacitors and resistors. Those knowledgeable in the art will appreciate that netlists may be represented in many particular forms, with a typical netlist comprising a database having a plurality of tables, each of which comprises a multiplicity of nets and associated data fields.

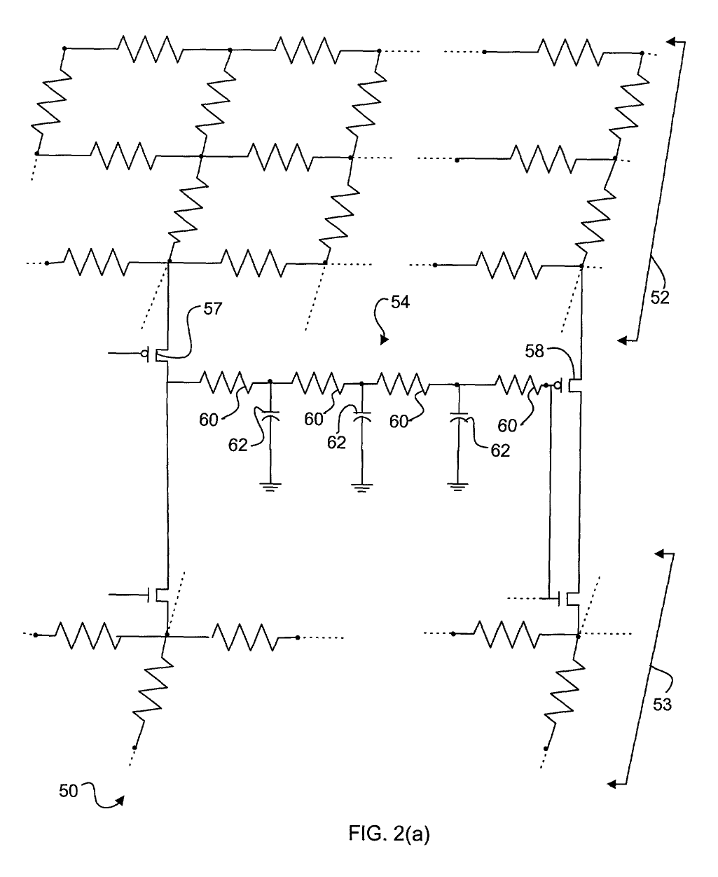

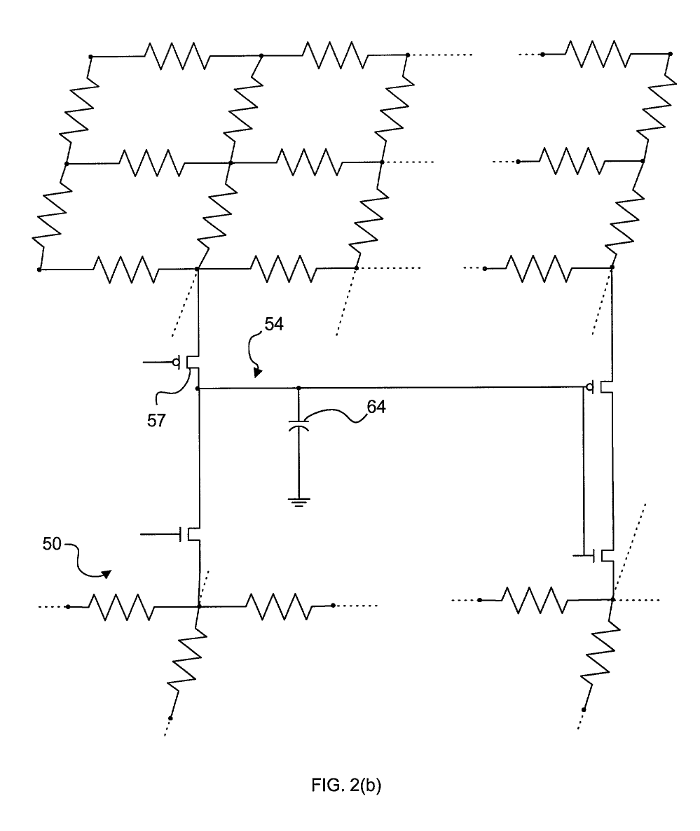

The electromigration study of the power grid will be performed by first selecting from the distributed model netlist the nets that comprise the power grid (block 12). That is, a group of nets will be selected that define or make up the power grid. With reference now made to the integrated circuit 50 graphically represented in a distributed 3-dimensional model in FIG. 2(a), a power grid 52 is represented by the connected nets at the highest level. The lowest level of the circuit 50 comprises a group of connected nets defining the ground grid 53. A plurality of secondary nets are then selected from the netlist that are connected to and isolated from the powergrid 52 by a transistor (block 14). As used herein, the term “connected” is not intended to be limited to direct connection (e.g., a secondary net may be “connected” to the first net even if one or more intermediary nets are therebetween). Depending on the hierarchal structure and organization of an IC and its netlist(s), it may be the case that all of the secondary nets of a netlist are ultimately connected to the power grid. That is, the secondary nets selected may comprise all of the remaining nets from a netlist other than the nets that comprise the power grid.

Preferably, these secondary nets are isolated from the power grid by a transistor. With reference again made to FIG. 2(a), a secondary net 54 shown below the power grid 52 and isolated therefrom by the transistor 57 may be selected. As used herein, the term “isolated” is intended to refer to a condition of being separated from. That is, the secondary net 54 is “isolated” from the power grid 52 by the transistor 57, with current flowing into the net 54 when the transistor 57 is in the “on” position and flowing into the gate of the transistor 58. It will be appreciated that as used herein, the term “isolated from the power grid by a transistor” refers to a condition of being separated from the power grid by one or more transistors. Accordingly, additional secondary nets could be located between the transistor 57 and the ground grid 53.

Also, it will be appreciated that the condition of being isolated from the grid refers to an isolating transistor on the current upstream side of the net. That is, it is not required for the net 54 to be isolated from the power grid 52 by a transistor on both the upstream and downstream sides. For instance, it will be appreciated that the net 54 could terminate in a receiver other than the transistor 58 gate.

In order to effectively analyze the power grid 52 for a purpose such as performance of an electromigration analysis, it will be required to consider the secondary net 54 that is connected to the grid and draws power from it. That is, the current traveling through the power grid 52 will be affected by the secondary net 54 when the transistor 57 is in a “closed” position and the net 54 draws current from the grid 52.

The method embodiment 10 next proceeds to compress the secondary net 54 in order to decrease the required memory and processor resources required to accommodate the netlist. An electromigration analysis generally studies the effects of current passing through the power grid 52 over time.

With reference again made to FIGS. 1 and 2(a), the distributed representation of the secondary net 54 is compressed by removing all of the resistors 60 from the net 54 (block 18), and by summing all of the capacitors 62 on the net 54 in order to assign the net 54 a total capacitance (block 20). As a result of these steps, the compressed secondary net may be represented as being free from resistors and as having a single equivalent capacitance associated with it.

This result is illustrated by the simplified model of the integrated circuit 50 shown in FIG. 2(b), where the secondary net 54 comprises only a single capacitor 64 representing the sum total capacitance of all of the capacitors 62 that were shown in the distributed model net 54 of FIG. 2(a). The secondary net 54 as represented in FIG. 2(b) may be thought of as being in a modified lumped model form, as it has all resistors removed and all the previously distributed capacitors 62 “lumped” into the single capacitors 64. The memory and processing resources required to accommodate the net 54 in this lumped form are thereby substantially reduced, with the result that valuable cost and time savings in performing a wide variety of tasks that involve manipulation of the secondary nets are achieved.

It will be appreciated that the model circuit 50 of FIG. 2 is quite small, and that in practice an integrated circuit, and particularly a VLSI, may comprises a multiplicity of secondary nets 54 that number into the five or six digits. Under such circumstances the memory savings achieved through practice of the invention will be considerable. It is theorized that memory savings of the order of halving or better of required memory will be achieve, in fact, for tasks such as an electromigration for a VLSI.

In essence, the embodiment 10 of the present invention can thereby be thought of as converting a distributed model net or netlist into a hybrid lumped/distributed model. That is, after the compression steps, the power grid nets will remain with capacitors and resistors in a distributed format, while secondary nets will have resistors removed and capacitors represented in a lumped format. The IC model is thereby simplified through the steps of the present invention without loss of information required for effective analysis for purposes such as electromigration study. Many problems of the prior art are thereby solved.

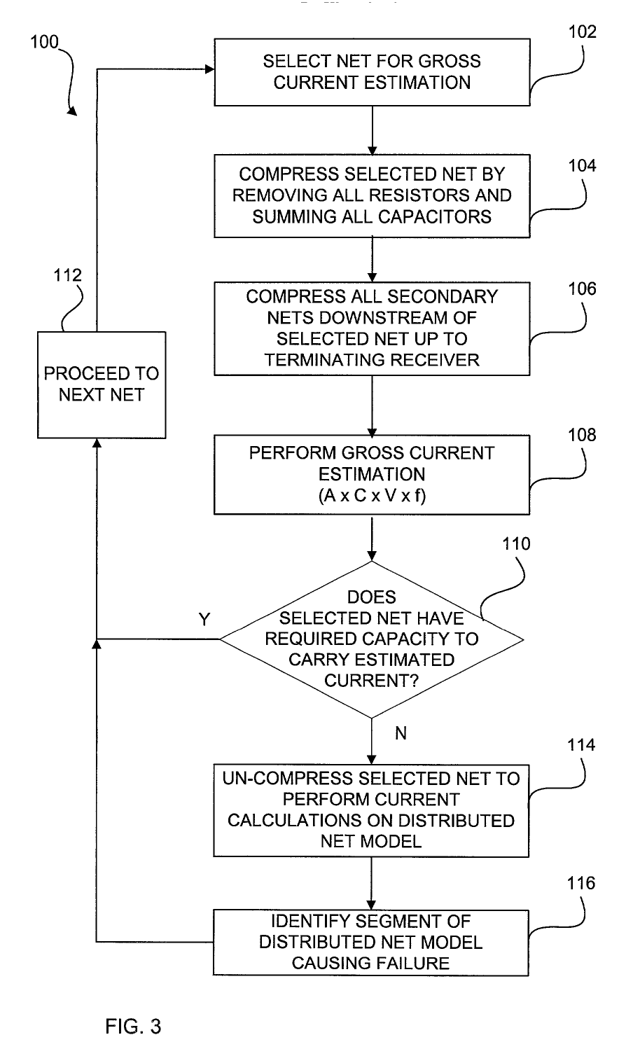

The flowchart of FIG. 3 illustrates an additional method embodiment 100 of the invention directed to performing gross current estimation on a circuit. Those skilled in the art will appreciate that methods for performing such estimations comprise estimating the current that flows through a selected portion of the circuit. This estimate can be compared to the physical current limitation of that circuit portion to determine whether the portion has sufficient capacity to carry the estimated current. Those knowledgeable in the art will also appreciate that estimated gross current can be calculated using the general relationship: I=A×C×V×f, where I is gross current, A is activity factor, C is downstream capacitance, V is voltage, and f is frequency.

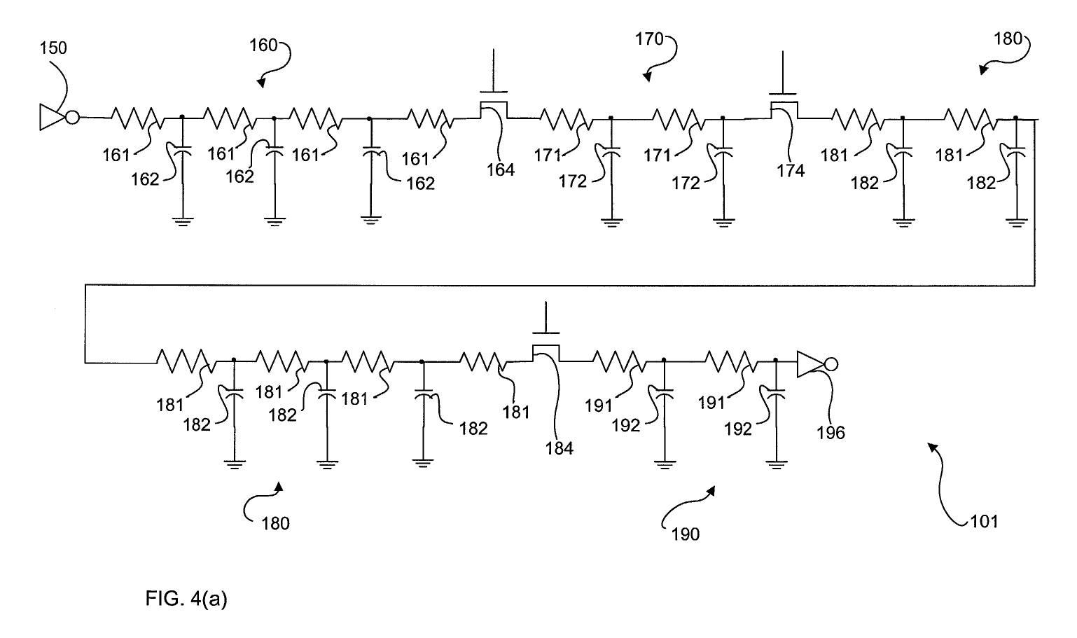

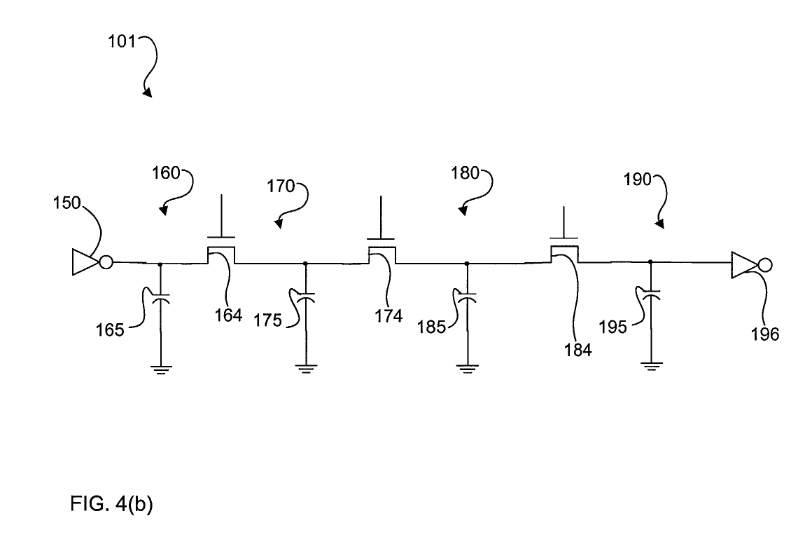

The present invention provides a method to substantially compress a circuit model or netlist while retaining information required to perform a gross current estimation. In particular, with reference now drawn to FIG. 3, an embodiment of the method of the invention 100 comprises an initial step of selecting a net to perform a gross current estimation on (block 102). By way of further illustration, FIG. 4(a) illustrates a plurality of nets 160, 170, 180, and 190 between the inverters 150 and 196. The nets are separated from one another by transistors 164, 174, and 184. FIG. 4(a) represents a distributed RC model, with each of the nets 160-190 comprising a plurality of individual resistors and capacitors. For example, the net 160 comprises three resistors 161 and three capacitors 162 distributed along its length.

Those skilled in the art will appreciate that the inverters 150 and 196 may comprise any of a number of components that are capable of substantially interrupting current flow. For example, the inverter 150 may comprise one or more transistors, such as a p-FET and an n-FET in series. Similarly, the inverter 196 may comprise a gate terminal of a transistor, or a transistor in an “open” or “off” condition whereby current will substantially not pass therethrough. Those skilled in the art will likewise appreciate that current may in practice leak through such components, and that accordingly as used herein a description of current “substantially not flowing” is not intended to refer to an absolute zero current flow condition that is free from current leakage or the like.

Those knowledgeable in the art will also appreciate that in considering the current that flows through the selected first net 160, it will be necessary to consider all of the capacitors downstream of that net that will have to be charged by current that flows through the selected net 160. Accordingly, the method embodiment 100 next comprises steps of compressing both the selected net 160 and the secondary nets 170, 180, and 190 that are downstream of the selected net and upstream of the inverter 196 and that thereby connect the first net 160 with the inverter 196 (blocks 104, 106). As current will not flow past the inverter 196 in the simple circuit of FIG. 4(a), no additional downstream nets need be considered for the gross current estimation.

In the method embodiment 100, the first selected net 160 and the secondary nets 170, 180, and 190 are compressed through steps of removing all resistors 161, 171, 181, and 191, respectively, from the distributed model nets, and summing the capacitors 162, 172, 182, and 192, respectively for each of the nets 160-190. FIG. 4(b) illustrates the circuit 101 with the nets 160, 170, 180 and 190 having been thus compressed. In essence, the compressed nets are represented in a “hybrid lumped” manner, with all of the resistors removed and with a single capacitor on each net 160-190 (capacitors 165, 175, 185, and 195, respectively) that represent the sum of all of the individual capacitors present in the distributed model. Thus the nets 160-190 have been compressed to an extent to significantly reduce the required memory and processor resources for manipulating them. Further, the nets 160-190 have been compressed in a manner such that they retain in their compressed form information required for performing a gross current estimation.

The method embodiment 100 next comprises a step of calculating such a gross current estimation (block 108). The result of the calculation is then compared to a current limitation of the net 160 under analysis (block 110). As used herein, the term “current limitation” is intended to broadly refer to a physical limit on the amount of current that can be carried by the particular net. Those knowledgeable in the art will appreciate that each net has a current limitation that results from factors such as the amount, geometry, and type of conducting material used to carry the current. By way of example, a net of an integrated circuit typically physically comprises a thin layer of metal deposited on a substrate. The width, depth, geometry, and type of metal used will contribute to the current limitation for the net. Those knowledgeable in the art will appreciate that determining current limitations is a fairly straightforward task that is not necessary to discuss in detail herein.

If the calculated gross current estimate does not exceed the current limitation for the net, the net may be deemed to have “passed” the current analysis. In this case, the embodiment 100 of the invention comprises proceeding to the next sequential net (block 112). With reference to FIG. 4 by way of example, assume that the gross current estimate analysis was conducted on the first net 160 considering the downstream nets 170-190. Further assume that the first net 160 passed the gross current estimate analysis. The method 100 comprise next selecting the net 170 for analysis (block 112), with downstream nets now comprising the nets 180 and 190 that separate the selected net 170 from the inverter 196. Once selected, the net 170 in its compressed form will be analyzed for its ability to carry the gross estimated current in consideration of the downstream nets 180 and 190 in their compressed form.

For purposes of further illustration, assume that the net 170 is deemed to fail the gross current estimation analysis. That is, assume that the calculated gross current (block 108) required to be carried by the net 170 exceeds its current limitation. Under these circumstances, the present method embodiment comprises a step of “un-compressing” the net 170 to perform gross current calculations on each segment of the un-compressed, distributed net.

With reference to FIG. 4 by way of further illustration, un-compressing the net 170 comprises converting the net 170 from its hybrid-lumped form of FIG. 4(b) with only a single capacitor 175 back into its distributed form as represented by FIG. 4(a) with a plurality of resistors 171 and capacitors 172 distributed along its length. Those knowledgeable in the art will appreciate that in this distributed representation, the net 171 is comprised of a plurality of individual segments. The present method embodiment comprises analyzing each of these individual segments to determine which fails the gross current analysis. In performing this analysis of each individual segment, the downstream nets 180 and 190 remain in their compressed hybrid lumped form so that memory and processor savings continue to be achieved.

The method embodiment 100 continues to analyze additional nets one by one moving downstream until the inverter 196 is reached. Those knowledgeable in the art will appreciate that it is of course not required to analyze the nets in any particular order, and that it is not even required to move downstream to analyze nets. By way of example, a method embodiment could comprise analyzing the most downstream net 190 first, with any of the upstream nets 160-180 then selected for analysis. Accordingly, the present invention is not limited to any particular sequence of net selection for analysis.

It will be appreciated that the present invention is directed to a method for compressing nets in a distributed format to a hybrid lumped format to achieve various advantages that include, but are not limited to, reduced complexity, reduced memory resources, reduced processor resources, and time savings. Although the general method of the invention has been illustrated herein through discussion of a power grid electromigration embodiment and through a gross current analysis embodiment, it will be appreciated by those knowledgeable in the art that the present invention will have numerous additional applications that make use of the novel compression steps. As an example, it will be appreciated that the present invention is not limited to practice in the form of a CAD or ECAD tool or system.

Those knowledgeable in the art will also appreciate that the present invention is well suited for practice in the form of a computer program product. Accordingly, embodiments of the present invention comprise computer program products comprising computer executable instructions embedded in a computer readable medium that when executed cause a computer to carry out the steps of method embodiments of the invention. It will therefore be appreciated that discussion made herein in reference to method embodiments of the invention may likewise apply to program product embodiments, with the understanding that the method steps may be carried out by a computer executing a program product of the invention. For example, the flowcharts of FIGS. 1 and 3 may be considered to be computer program product embodiment flowcharts in addition to method embodiment flowcharts.

Those knowledgeable in the art will appreciate that computer program product embodiments may comprise computer readable instructions created using programming languages such as C++, object oriented languages, and the like, that have been compiled or otherwise converted into a machine readable format. These instructions may be embedded in a computer readable medium that may comprise, by way of example, magnetic or optical media such as disks and the like. It will also be appreciated that computer program products of the invention may utilize computer or communications networks, with an example being the internet, so that they may be operable remotely over a network. In such instances, a program product embodiment may comprise internet protocol operability.

It will also be appreciated that the term “computer” as used herein is intended to broadly refer to processor-based devices capable of executing computer readable instructions. A “computer” as used herein is thereby not limited to desktop computers, laptop computers, mainframe computers, and the like, but may also comprise devices such as a dedicated circuit testing device and the like.

The advantages of the disclosed invention are thus attained in an economical, practical, and facile manner. While preferred embodiments and example configurations have been shown and described, it is to be understood that various further modifications and additional configurations will be apparent to those skilled in the art. It is intended that the specific embodiments and configurations herein disclosed are illustrative of the preferred and best modes for practicing the invention, and should not be interpreted as limitations on the scope of the invention as defined by the appended claims.

What is claimed is:

1. A method for compressing a distributed integrated circuit model comprising the steps of:
selecting at least a first net from a plurality of nets contained in the distributed integrated circuit model; and
compressing at least a second net connected to said first net by removing all resistors from said at least a second net, and assigning said at least a second net a total capacitance representing a sum of all capacitors on said at least a second net.

2. A method for compressing a distributed integrated circuit model as defined by claim 1 wherein said at least a second net is isolated from said first net by a transistor.

3. A method for compressing a distributed integrated circuit model as defined by claim 1 wherein said first net and said second net are contained within a single netlist.

4. A method for compressing a distributed integrated circuit model as defined by claim 1 wherein:
said at least a first net comprises a plurality of first nets defining a power grid, and said at least a second net comprises a plurality of secondary nets each being connected to said power grid and isolated from said power grid by a transistor.

5. A method for compressing a distributed integrated circuit model as defined by claim 1 further comprising the steps of:
compressing said at least a first net by removing all resistors from said net and summing all capacitors from said net.

6. A method for compressing a distributed integrated circuit model as defined by claim 5 wherein said at least a second net comprises a plurality of second nets all connected to said first net and downstream of said first net

7. A method for compressing a distributed integrated circuit model as defined by claim 6 wherein said plurality of second nets comprise all nets connected downstream of said first net and upstream of an inverter.

8. A method for performing an electromigration analysis on a distributed integrated circuit comprising the steps of:
selecting a group of first nets defining a power grid from a netlist, said netlist comprising a distributed RC model;
compressing a plurality of secondary nets connected to said power grid and isolated from said first net by a transistor by removing resistors from said secondary nets and assigning to each of said secondary nets a total capacitance value equal to the sum of capacitance of all the capacitors on respective of said secondary nets; and
performing an electromigration analysis on said power grid using said first nets and said compressed secondary nets.

9. A method for performing a gross current estimation on a distributed integrated circuit comprising the steps of:
selecting a first net to perform the gross current estimation on, said first net having a distributed model;
compressing said first net by removing all resistors from said first net and summing all capacitors on said fist net;
compressing at least a secondary net connected to said first net and downstream of said first net by removing all resistors from said at least a secondary net and summing all capacitors on said at least a secondary net; and
calculating a gross current estimation for said first net using said compressed at least a secondary net.

10. A method for performing a gross current estimation on a distributed integrated circuit as defined by claim 9, wherein said at least a secondary net comprises a plurality of secondary nets connecting said first net with a downstream inverter through which substantially no current flows.

11. A method for performing a gross current estimation on a distributed integrated circuit as defined by claim 10 wherein said inverter is selected from the group consisting of a gate terminal of a transistor or a transistor in an off condition.

12. A method for performing a gross current estimation on a distributed integrated circuit as defined by claim 9, wherein said first net has a current limitation, wherein said distributed model of said first net has a plurality of individual segments, and wherein the method further comprises the steps of:
determining whether said calculated gross current estimation for said first net exceeds the current limitations for said first net; and
un-compressing said first net if said calculated gross current estimation exceeds the current limitations for said first net by returning said compressed first net to a distributed model and performing a gross current estimation on said individual segments of said distributed model using said compressed at least a secondary net.

13. A method for performing a gross current estimation on a distributed integrated circuit as defined by claim 12 further comprising the step of:
selecting one of said compressed at least a secondary net to perform a gross current estimation on if said calculated gross current estimation for said first net does not exceed said first net current limitation; and
calculating a gross current estimation on said selected one of said compressed at least a secondary nets using said selected compressed one of said at least a secondary nets and remaining of said compressed at least a secondary nets.

14. A computer program product for compressing a distributed integrated circuit model, the program product comprising computer executable instructions embedded in a computer readable medium that when executed cause a computer to:
select at least a first net from a plurality of nets contained in the distributed model integrated circuit model; and
compress at least a secondary connected to said first net by removing all resistors said at least a secondary net and summing all capacitors on said at least a secondary net.

15. A computer program product for compressing a distributed integrated circuit model as defined by claim 14 wherein said at least a first net comprises a plurality of nets defining a power grid, and said at least a secondary net comprises a plurality of secondary nets connected to said power grid, each of said secondary nets isolated from said power grid by at least a transistor.

16. A computer program product for compressing a distributed integrated circuit model as defined by claim 14 wherein said program instructions when executed further cause the computer to compress said at least a first net by removing all resistors from said first net and summing all capacitors on said first net, and wherein said at least a secondary net comprises a plurality of secondary nets connecting said first net with an inverter through which substantially no current flows.

17. A computer program product for performing an electromigration analysis on an integrated circuit power grid, the program product comprising computer readable instructions embedded in a computer readable medium that when executed cause a computer to:
compress a plurality of secondary nets connected to a plurality of first nets that define the power grid, each of said secondary nets isolated from said first nets by a transistor, wherein compressing comprises removing resistors from said secondary nets and assigning to each of said secondary nets a total capacitance value equal to the sum of capacitance of all the capacitors on respective of said secondary nets; and
perform an electromigration analysis on the power grid using said first nets and said compressed secondary nets.

18. A computer program product for performing a gross current estimation on a distributed integrated circuit, the program product comprising computer executable instructions embedded in a computer readable medium, the instructions when executed causing the computer to:
select a first net to perform the gross current estimation on, said first net having a distributed model, compress said first net by removing all resistors from said first net and summing all capacitors on said fist net;
compressing at least a secondary net by removing all resistors from said at least a secondary net and summing all capacitors on said at least a secondary net, said at least a secondary net being connected to said first net downstream of said first net and upstream of an inverter through which substantially no current flows; and
calculating a gross current estimation for said first net using said compressed at least a secondary net.

19. A computer program product for performing a gross current estimation on a distributed integrated circuit as defined by claim 18, wherein said first net has a current limitation, wherein said distributed model of said first net has a plurality of individual segments, and wherein the computer readable instructions when executed further cause the computer to:
determine whether said calculated gross current estimation for said first net exceeds the current limitations for said first net;
un-compress said first net if said calculated gross current estimation exceeds the current limitations for said first net by returning said compressed first net to said first net distributed model and performing a gross current estimation on individual segments of said first net distributed model individual segments using said compressed at least a secondary net; and
select one of said compressed at least a secondary nets to perform a gross current estimation on if said calculated gross current estimate for said first net does not exceed said first net current limitation; and
calculate a gross current estimation on said selected one of said compressed at least a secondary nets using said selected compressed one of said at least a secondary nets and remaining of said compressed at least a secondary nets.

20. A computer program product as defined by claim 18 wherein said at least a secondary net comprises a plurality of secondary nets, said plurality of secondary nets connecting said first net with said inverter.
